(19) United States
(12) Patent Application Publication
(10) Pub. No.: US 2007/0205876 A1
(43) Pub. Date: Sep. 6, 2007

(54) RFID-based systems and methods for preventing hi-jacker from using airplanes as guided missiles, vessels as guided torpedoes, and automotive or rail conveyances as bombs

(76) Inventor: Hap Nguyen, Westminster, CA (US)

Correspondence Address: Donald Bollella;DB Technical Consulting, 126 Almador, Irvine, CA, 92614, US

(21) Appl. No.: 11/281,941

(22) Filed: Nov. 16, 2005

Related U.S. Application Data
(60) Provisional application No. 60/628,503, filed on Nov. 16, 2004.
(60) Provisional application No. 60/695,707, filed on Jun. 30, 2005.

(51) Int. Cl. B60R 25/10

(52) U.S. Cl. 340/426.12; 340/5.52; 340/5.61; 307/9.1

(57) ABSTRACT

An anti-hijacker system for use in association with a transportation conveyance having an engine or motor system. The anti-hijacker system includes an RFID tag associated with an authorized user of the transportation conveyance and a receiver enabled to read a signal transmitted from the RFID tag. The system further includes a computer operatively connected to the receiver and the engine or motor system of the transportation conveyance so that in the absence of an expected signal from the RFID tag, the computer takes operational control of the engine or motor system. The computer may disable the engine or place the conveyance on autopilot. Related methods include concealing an RFID tag on the person of an authorized user of the transportation conveyance and disabling operation of the engine or motor system of the transportation conveyance when an expected signal from the RFID tag is not received in an expected manner.

### CROSS REFERENCE TO RELATED APPLICATIONS

The present application claims the benefit of priority from U.S. Provisional Application Ser. No. 60/628,503 filed Nov. 16, 2004; U.S. Provisional Application Ser. No. 60/695,707 filed Jun. 30, 2005; and U.S. patent application Ser. No. 11/212,469 filed Aug. 25, 2005 all of which are incorporated herein by reference in their entirety.

### BACKGROUND OF THE INVENTION

1. Field of the Invention

This invention relates in general to preventing terrorist attacks and, in particular, to preventing planes, boats, trains, or automotive vehicles from being used as attack weapons. More specifically, but without restriction to the particular embodiments hereinafter described in accordance with the current best mode of practice, this invention relates to RFID-based systems and methods for preventing a hijacker from using an airplane as a guided missile, a vessel as a guided torpedo, or a truck, train, or other transportation conveyance as a bomb or explosive weapon.

2. General Discussion and Related Art

Since Sep. 11, 2001, there has been an increased need for preserving public safety against terrorist attacks. In typical attacks, public or private transportation conveyances such as planes, boats, or automotive vehicles are used as explosive attack weapons and deployed against public targets such as buildings or in some cases other boats or ships. In the case of trains, subways, streetcars, and trolleys, the rail conveyance itself has been employed as both the attach weapon and terrorist target.

As of the date of the present invention, there has not been proposed any known practical system capable of preventing planes, boats, trains, or automotive vehicles from being used as attack weapons. There is, therefore, a need for a simple, cost effective system for preventing a hijacker from using an airplane as a guided missile, a vessel as a guided torpedo, a car, truck, or other automotive vehicle, or train, subway, trolley, or other rail conveyance as a guided bomb to thereby increase national security and homeland security of the United States and around the world in other countries.

The inventor hereof has previously contributed to various arts related hereto as disclosed, for example, in U.S. Pat. No. 6,771,168 entitled “Automotive System to Prevent Car Jacking” which was filed on Apr. 24, 1995 and issued on Aug. 3, 2004; U.S. patent application Ser. No. 11/212,469 entitled “Anti-Carjacking Apparatus, Systems, and Methods for Hi-Speed Pursuit Avoidance and Occupant Safety” filed Aug. 25, 2005; International Application No. PCT/US2005/030235 entitled “Anti-Carjacking Apparatus, Systems, and Methods for Hi-Speed Pursuit Avoidance and Occupant Safety” also filed Aug. 25, 2005; U.S. Provisional Application Ser. No. 60/695,707 entitled “Anti-Carjacking Apparatus, Systems, and Methods for Hi-Speed Pursuit Avoidance and Occupant Safety” filed Jun. 30, 2005; U.S. Provisional Application Ser. No. 60/628,503 entitled “System for Preventing Hi-Jacker From Using an Airplane as a Guided Missile, a Vessel as a Guided Torpedo, and a Truck or Train as a Guided Bomb” filed Nov. 16, 2004; and U.S. Provisional Application Ser. No. 60/604,734 entitled “Anti-Carjacking Apparatus, Systems, and Methods for Hi-Speed Pursuit Avoidance” filed Aug. 25, 2004. All of these patent and application disclosures being herein incorporated by reference in their respective entireties as if fully repeated herein below.

### OBJECTS AND SUMMARY OF THE INVENTION

It is, therefore, an object of the present invention to provide a practical system capable of preventing planes, boats, trains, automotive vehicles, or other transportation conveyances from being used as attack weapons.

Another object of this invention is to provide a simple, cost effective system for preventing a hijacker from using an airplane as a guided missile, a vessel as a guided torpedo, or an automotive or rail conveyance as a guided bomb.

It is a further object of the present invention to increase national security and homeland security in the United States and in other countries.

Yet another object of this invention is to determine whether a transportation conveyance is being operated by an authorized user.

These and other objects are attained in accordance with the present invention wherein there is provided an anti-hijacker system for use in association with a transportation conveyance having an engine or motor system. The anti-hijacker system includes an RFID tag or emitter associated with an authorized user of the transportation conveyance; a receiver enabled to read a signal transmitted from the RFID tag; and a computer operatively connected to the receiver and the engine or motor system of the transportation conveyance so that in the absence of an expected signal from the RFID tag, the computer controls operation of the engine or motor system. This system may further include a GPS receiver operatively linked to the computer to thereby enable the computer to determine the location of the transportation conveyance at any desired time.

According to one aspect of a particular embodiment of this system, there is further provided a biometric ID unit enabled to identify the authorized user by a personal biological characteristic unique to the authorized user. This biometric ID unit may advantageously require an input password to be enabled to identify the authorized user by a personal biological characteristic unique to the authorized user.

In one preferred embodiment of the present invention there is provided a radio transceiver operatively connected to the computer. This radio transceiver is enabled to receive a control signal from a remote location.

In one specific application of this system, the transportation conveyance is an airplane. In this application, the anti-hijacking system includes an auto pilot system linked to the computer. The autopilot system is activated by the computer to autonomously control the airplane when the computer has determined the absence of the expected signal from the RFID tag.

In certain applications of the present invention, the computer of the anti-hijacker system disables normal operation of the engine or motor system of the transportation conveyance in the absence of the expected signal from the RFID tag.

The system may further advantageously include a sleeping gas dispensing system that is operatively controlled by the computer so that upon a controlled command, the sleeping gas dispensing system is activated to render unconscious any would-be hijacker.

In another preferred embodiment of this invention, the anti-hijacker system is provided with a surveillance system operatively connected to the computer. This surveillance system may include video capability and, or alternatively, audio capability.

According to another aspect of this system, the RFID tag is concealed on the person of the authorized user. The authorized user may be a pilot, captain, conductor, driver, or other person responsible for operating the transportation conveyance. Alternatively, the authorized user may be a law enforcement officer, intelligence agent, military personnel, or other person acting as a passenger on the transportation conveyance.

In accordance with another aspect of this invention, there is also provided a method of preventing a transportation conveyance from being hijacked. This method includes the steps of concealing an RFID tag on the person of an authorized user of the transportation conveyance; and taking remote control of the engine or motor system of the transportation conveyance when an expected signal from the RFID tag is not received in an expected manner.

According to another aspect of the present invention there is further provided an alternative method of preventing a transportation conveyance from being hijacked. This method includes the steps of concealing an RFID tag on the person of an authorized user of the transportation conveyance; and disabling operation of the engine or motor system of the transportation conveyance when an expected signal from the RFID tag is not received in an expected manner.

In either of these methods, the authorized user may be a pilot, captain, conductor, driver, or other person responsible for operating the transportation conveyance. Alternatively, the authorized user may advantageously be a law enforcement officer, intelligence agent, military personnel, or other person acting as a passenger on the transportation conveyance.

In accordance with yet another aspect of this invention there is provided another alternative method of preventing a transportation conveyance from being hijacked. This particular method includes the steps of providing an authorized user of the transportation conveyance with an RFID tag that transmits a known signal; providing a receiver enabled to read the signal transmitted from the RFID tag; and providing a computer operatively connected to the receiver and the engine or motor system of the transportation conveyance so that in the absence of an expected signal from the RFID tag, the computer controls operation of the engine or motor system.

This method may further include the step of providing a GPS receiver operatively linked to the computer to thereby enable the computer to determine the location of the transportation conveyance at any desired time. Alternatively or in combination therewith, this method may further include the step of providing a biometric ID unit enabled to identify the authorized user by a personal biological characteristic unique to the authorized user. If so included, the method may further require an input password to the biometric ID to thereby be enabled to identify the authorized user by a personal biological characteristic unique to the authorized user. In certain embodiments of this particular method, there may be further provided the step of providing a radio transceiver operatively connected to the computer. In this embodiment, the radio transceiver may be enabled to receive a control signal from a remote location.

Other aspects of the present invention are directed to a biometric and password system that includes a reader implemented to take a biometric reading from a user to determine whether the user is an authorized user, an input device enabled to receive a password and input the password into the system to determine whether the user has inputted an authorized password, and a processor configured to compare the biometric reading to the inputted password to determine whetherthe inputted password matches with the biometric reading. The reader of this system may include a heart sensor for taking a temperature reading of the user. The system is preferably linked to a computer having a database used to store known biometric IDs and passwords.

In one specific embodiment of the biometric and password system there is provided a piloting control and security system for use in an aircraft. This system includes a yoke including a thumb cradle formed therein. The thumb cradle has a reader capable of reading a fingerprint of a user that places a finger in the thumb cradle and the reader is operatively connected to a processor. the system further includes a password input device operatively connected to the processor so that when the user's fingerprint has been read by the reader and a password inputted into the password input device, the processor determines whether the user is an authorized user. Also in this embodiment, the thumb cradle may advantageously include a heat sensor enabled to take a temperature reading from the user.

In other specific embodiments of the biometric and password system according to this invention there is alternately provided a steering control and security system for use in an automotive vehicle, and a steering control and security system for use in watercraft, the system. The system for use in an automotive vehicle includes a steering wheel including a thumb cradle formed therein while the embodiment for use in watercraft includes a pilot wheel including a thumb cradle formed therein. In each case, the thumb cradle has a reader capable of reading a fingerprint of a user that places a finger in the thumb cradle, and the reader is operatively connected to a processor. Each of these systems also includes a password input device operatively connected to the processor so that when the user's fingerprint has been read by the reader and a password inputted into the password input device, the processor determines whether the user is an authorized user. In either case the thumb cradle may include a heat sensor enabled to take a temperature reading from the user.

According to yet another aspect of this invention there is provided a method for determining authorized use of a transportation conveyance. This method includes the steps of 1) requiring a user of the transportation conveyance to carry an RFID tag, 2) requiring the user to input a password into a computer system associated with the transportation conveyance, 3) requiring the user to periodically conduct a biometric check during the course of operation of the transportation conveyance, and 4) initiating a security protocol in the event of an incorrect password entry, a negative biometric check, or a failure to receive an expected signal from the computer system.

### BRIEF DESCRIPTION OF THE DRAWING FIGURES

Further objects of the present invention together with additional features contributing thereto and advantages accruing therefrom will be apparent from the following description of certain preferred embodiments of the invention which are shown in the accompanying drawing wherein:

FIG. 1 is a block diagram of the anti-attack system according to the present invention that may be implemented in any transportation conveyance including planes, boats or ships, trains or subway cars, and all types of automotive vehicles;

FIG. 2 is a perspective pictorial representation of one embodiment of a biometric ID and password device according to a particular aspect of this invention which includes a partial logic flow diagram associated with a method of use relating thereto;

FIG. 3 is a broken-away perspective view of the biometric ID and password device of FIG. 2 implemented in the yoke of an aircraft;

FIG. 4 is a broken-away perspective view of the biometric ID and password device of FIG. 2 implemented in the steering wheel of an automotive vehicle such as a car, truck, or bus;

FIG. 5 is logic flow chart showing one of the various methods associated with the RFID and Biometric ID systems according to the present invention as applied to an aircraft;

FIG. 6 is a diagrammatic representation of the United States map showing the location of certain cites and related aircraft loitering zones according to various methods of the present invention;

FIG. 7 is a pictorial schematic view of a variety of different system configurations according to the present invention involving remotely dispatched control and security protocols from a fixed location for application to a transportation conveyance which has indicated a security alert;

FIG. 8 is a perspective pictorial and block diagram view of a system according to the present invention illustrating communication with an authorized ground radio;

FIG. 9 is a block diagram similar to FIG. 8 showing alternative options for implementation of the ground radio system with various authorized dispatchers;

FIG. 10 is a block diagram showing some of the principal components of the ground radio system of this invention as implemented in association with the authorized dispatchers of FIG. 9;

FIG. 11 is a rear perspective view of a tanker truck showing in phantom line the truck's computer and an RFID embedded license plate according to another aspect of the present invention;

FIG. 12 is a block diagram depicting the license plate of the present invention cooperatively interacting with the RFID reader and engine control unit of an RFID equipped truck of FIG. 11;

FIG. 13 is a block diagram illustrating the principal components of the RFID embedded license plate implemented according to the present invention;

FIG. 14 is logic flow chart showing one of the various methods associated with the RFID embedded license plate according to the present invention;

FIG. 15 is a top view of a tanker truck in a street-level authorization and control zone illustrating an interactive vehicle ID, authentication, and control system and method according to another principal aspect of the present invention;

FIG. 16 is a perspective view pictorial diagram of the interactive vehicle ID, authentication, and control system represented in FIG. 15 as implemented according to the present invention;

FIG. 17 is a block diagram of the principal components of the interactive vehicle ID, authentication, and control system illustrated in FIGS. 15 and 16; and

FIG. 18 is a logic flow chart showing one of the various preferred methods associated with the street-level authorization and control zone aspect of the present invention.

### DETAILED DESCRIPTION OF THE PREFERRED EMBODIMENTS

The present invention is a system for use in airplanes, water born vessels, trains, subways, streetcars, trolleys, and automotive vehicles including heavy duty hazardous material carrier trucks. The invention is employed to prevent hijacking attempts and thereby thwart use of such vehicles as terrorist attack weapons.

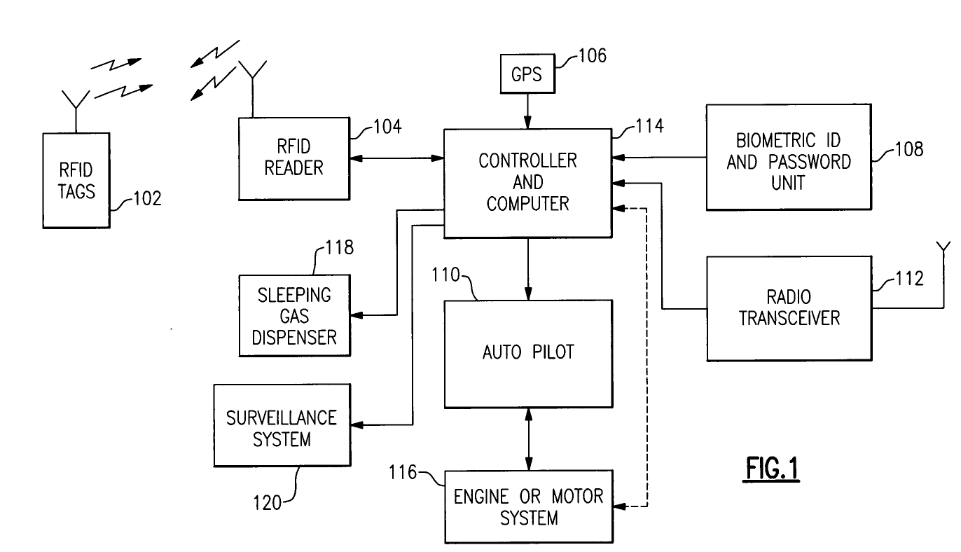

The system includes a Radio Frequency Identification (RFID) tag 102, FIG. 1, kept or maintained by an authorized user or rider of the conveyance and an interrogating system, tag reader, or RFID reader 104 on the conveyance that periodically sends out interrogating signals. The RFID tag 102 responds to the interrogating signals of the tag or RFID reader 104 by emitting an authorized code that confirms that the pilot, captain, conductor, or driver has authorization to operate the plane, vessel, train, automotive vehicle, or other transportation conveyance. In some implementations of the present invention, the user or rider authorized to have custody and control of the RFID tag 102 is the pilot, captain, conductor, or driver of the conveyance. In other embodiments hereof, the user or rider authorized to have custody and control of the RFID tag 102 may be a public service employee such as a law enforcement officer, intelligence agent, or military personnel.

The system also includes use of the Global Positioning System (GPS) 106, and integration of a heat sensitive (body temperature) Biometric ID (iris, thumb, or future available technology) system or unit 108, an autopilot or auto-control system 110, a radio transceiver 112, and a computer with controller 114 as shown in FIG. 1. The autopilot system 110 is operatively and interactively connected to an engine or motor system 116, FIG. 1, of the respective transportation conveyance. In embodiments hereof where the autopilot system 110 is not employed as a necessary or desired component of the integrated system, the computer and controller 114 are linked directly to the engine or motor system 116 of the particular transportation conveyance at hand. This connection is represented in FIG. 1 by the dashed arrow line between the computer 114 and engine or motor system 116.

The RFID tag 102 and Biometric ID unit 108 are employed to identify authorized pilots, captains, conductors, drivers, law enforcement officers, intelligence agents, or military personnel who have been given authority according to methods of use of the present invention. According to these certain aspects of the present invention, only such persons duly authorized are technically enabled to operate the respective transportation conveyance.

The GPS 106 is used to determine at any given time, the geographical location or position of any transportation conveyance equipped with the present system.

The computer 114 is equipped with a program that manages the input and output data to and from the autopilot 110, engine system 116, and other components of the present system. The computer memory includes a data base of authorized persons and corresponding biometric IDs as well as RFIDs. This data base may also include, for example, important characteristic information of airports, seaports, bus stops, train or subway stations, and pre-designated loitering areas.

In the embodiment of the present invention implemented for use in an airplane, when an authorized pilot starts a trip and as he or she approaches the cockpit, the RFID reader 104 as operatively linked to the computer 114 asks for an RFID. If a recognized or authorized ID is transmitted and received, the computer prompts the pilot for a password that may be unique for each trip and, or alternatively, a biometric ID such as a thump print preferably taken with simultaneous body heat detection. If this step is also passed successfully, then the engine system 116 will remain in an operative condition and the plane will stand ready for normal operation in an uninterrupted manner. After successful completion of the security protocol according to these aspects of the present invention, the pilot can then start a trip uneventfully as in the case of tens of thousand of flights which occur worldwide on a daily basis.

Once in flight, every 15 minutes to 30 minutes, for example, the pilot is required to answer a periodic request from the biometric ID unit 108. To prevent a hijacker from using a dead body organ for identification which would reach room or local temperature soon after death, the biometric ID unit may include a heat detection capability to determine that the body part being used for identification purposes, for example a thumb or finger, is at normal body temperature. This time interval may be varied to any desired length and is easily programmed or changed within the computer 114. In the event of a hijack, if the pilot is killed or removed alive from cockpit, the computer 114 no longer receives an expected input signal from the RFID tag reader 104 or the biometric ID unit 108 at the preset cycle.

At the first moment in the cycle missing an expected ID, either RF or biometric or both, the computer will wait, preferably for three minutes for example (the cycle time is programmable), then ask for a biometric ID. If this interrogation does not receive the correct ID, then a security procedure of the present invention will be initiated.

When initiated as indicated above, one particular security procedure or protocol of the present invention instructs the plane to turn on the autopilot 110 and sends out a distress signal. From this point on, the control of the airplane will be autonomous or answered by radio command via the radio transceiver 112 from a government authority or otherwise duly authorized security organization. The autopilot 110 is implemented so that it can only be disabled from radio command. From the GPS data, the computer 114 also knows where the plane or vessel is and directs the plane via the auto pilot to designated airports or unpopulated areas (as stored in the computer data base). Alternatively, the computer and auto pilot may direct the plane to a heading to open water with instructions to circle the plane in a holding pattern while waiting for government or authorized action.

An optional tear gas sleeping gas dispenser system 118 and, or alternatively, an array of hidden cameras in a surveillance system 120 may be advantageously installed in the cabin, cockpit, or driver's seat area and remotely used to put the hijacker or hijackers to sleep with intervention by the government authority via a radio command received by the radio transceiver 112. Sleeping gas that is odorless and invisible is preferred since using tear gas may initially prompt the would-be hijacker to commit further undesired behaviors. The surveillance system 120 may include both video and audio capabilities. These video and audio capabilities surveillance may be one-way or two-way.

For ground applications such as in automobile vehicles, trains and subway cars, or for water-borne applications such as in boats and ships, the autopilot is not necessarily needed. The computer may simply turn the engine off and send a distress signal when no proper or expected RF or biometric ID signal is detected by the RFID tag reader 104 or the biometric ID unit 108.

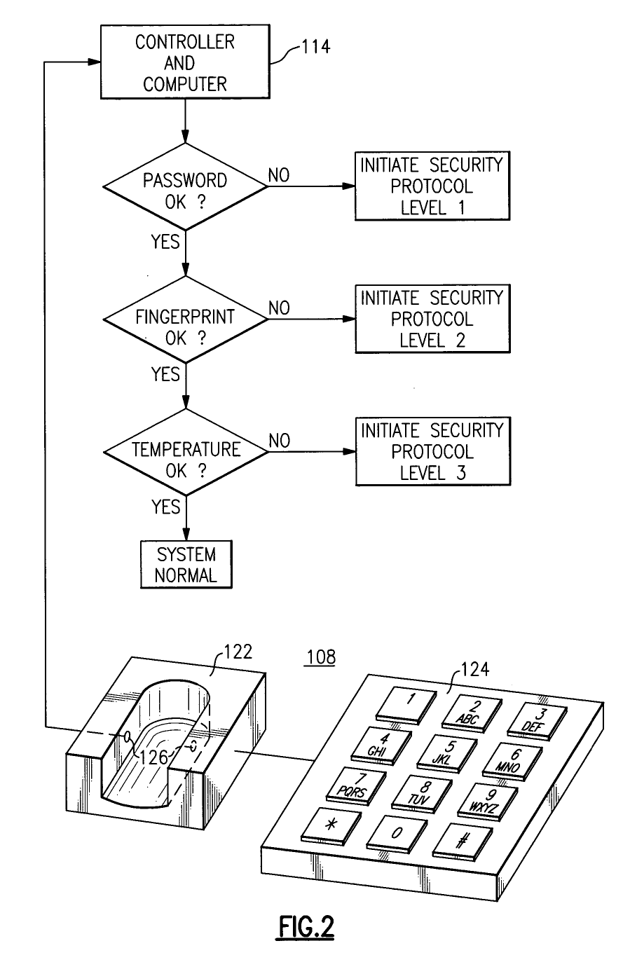

With reference now to FIG. 2, there is shown a perspective pictorial representation of the biometric ID and password unit 108 according to one particular aspect of this invention. The biometric ID unit illustrated includes a thumb cradle 122 and an input device 124 which in this embodiment is shown as 12 button key pad. The input device 124 may alternatively be implemented as a voice recognition input system, touch screen input, or any other suitable type of input device that an authorized user would employ to input a password or other type of authorization code to be received by the computer and controller 114. The thumb cradle 122 may also be implemented to take a reading of any finger rather the simply the thumb of a user. The thumb cradle 122 uses a scanning or reading technique, for example similar to bar code scanning, to read the finger print from the user's finger or thumb. In this manner, when an authorized user's finger prints are stored in the computer memory, the computer performs a cross check with the list of authorized user finger prints with the live input into the cradle by the authorized user periodically thought the travel time of the transportation conveyance. Other current or future technologies and methods may be implemented in the thumb cradle 122 to obtain an accurate fingerprint reading. These may include, for example, touch screen technology or sensitive heat pattern recognition systems. As discussed above, if the computer 114 does not receive a proper input reading during the periodic scheduling, the computer will initiate one of the security protocols according to the present invention. The thumb cradle 122 may also include heat sensors 126 to take a temperature reading of the thumb or finger as it rests in the cradle. If the temperature reading is in the expected proper range of the human body temperature and the fingerprint and password check are both positive to indicate presence of an authorized user, the system will report normal use. The proper range for body temperature as detected from the thumb or finger may be set at 98 degrees Fahrenheit plus or minus 1, 2, 3, or 4, degrees, for example. If, however, the fingerprint check is positive but the temperature check is negative, the system will initiate one of the protocols according to the present invention. For example, if the password check is negative a Level 1 security protocol may be initiated. This Level 1 security protocol may include, for example, a pause of a predetermined time that may be preferably between 30 seconds and 10 minutes to allow an authorized user to re-enter his password in the case of an inadvertent incorrect input on the first attempt. If the password check is negative, and remains negative after a set predetermined time period, then the security protocol may be escalated to Level 2 wherein the cockpit surveillance system 120, FIG. 1, is activated by authorized ground control personnel. In discussed above, the surveillance system 120 may include video and two-way radio so that the ground control may have visual inspection of the cockpit and audio communication with the pilot. If it is then determined by ground control that all operating systems are normal and there is no security event, the security protocol will then be de-escalated. If on the other hand, for example, video and audio surveillance is non-operative or has been intentionally disabled, while the fingerprint check is positive but the heat check is negative, the security protocol may be escalated to Level 3 wherein ground control takes remote control of the aircraft and initiates autopilot until an all clear condition may be verified at which time control of the aircraft may be returned to the authorized pilot or a newly authorized pilot. The above examples of security protocols are present by way of example and not intended to be limiting. As would be readily apparent in view of the present disclosure, a vide variety of different security protocols may be implement according to the present invention given the system attributes discussed in detail with reference to FIGS. 1 and 2. For example, ground control may take control of the aircraft at any desired point by placing the aircraft on autopilot. Similarly, the sleeping gas dispenser 118, FIG. 1, may be remotely activated in the aircraft at any desired or determined point under differing circumstances. In addition, the sleeping gas dispensing system may be mechanically implemented in both the cockpit and cabin, and if mechanically implemented in cabin may be implemented therein in different sections each of which being remotely individually controllable. In this manner, ground control may remotely release and dispense sleeping gas in the cockpit only or in the cockpit and cabin, or in the cabin only, or in any different sections thereof with or without release in the cockpit. Such localized releases of sleeping gas may also be timed in a fashion to suit the particular on-board security situation as determined by ground control.

In view of the above, it should be understood that each of the above security protocols 1, 2, and 3 are presented herein by way of example and are not intended to be limiting as to the wide variety of possible security protocols that may readily be implemented give the various components and functionalities of the present invention.

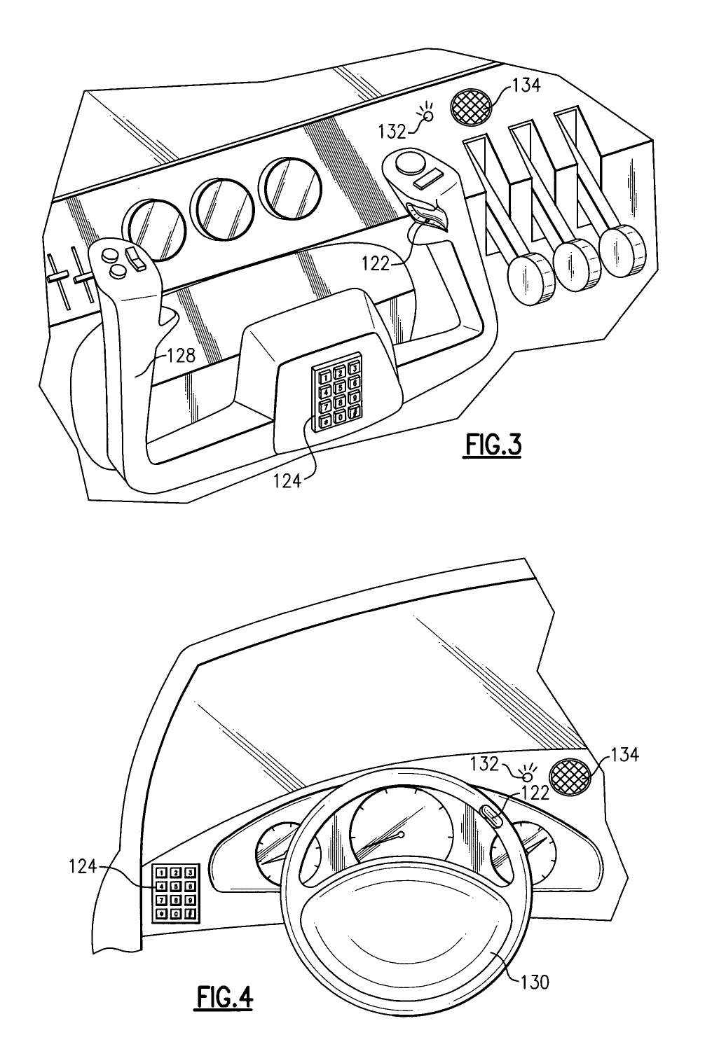

Referring now to FIG. 3, there is shown a broken-away perspective view of the biometric ID and password unit 108 of FIG. 2 implemented in an aircraft cockpit. Thus in accordance with one specific embodiment of the biometric ID and password unit 108, the input device 124 as shown in a key pad implementation and the thumb cradle 122 are integrated into an aircraft yoke 128 as illustrated. In this manner as the pilot continues to operate the plane, a security protocol of the present invention requires the pilot to depress his or her thumb in the thumb cradle 122 periodically so that ground control may verify the continued operation of the plane by an authorized user. The password input device 124 any be require only to initiate operation of the aircraft or alternatively also required during timed intervals during the entire course of the flight. The time intervals for repeated inputting of the password into the input device 124 may be of a longer, shorter, or same duration as the time intervals for repeated input of the thumb print into the thumb cradle 122.

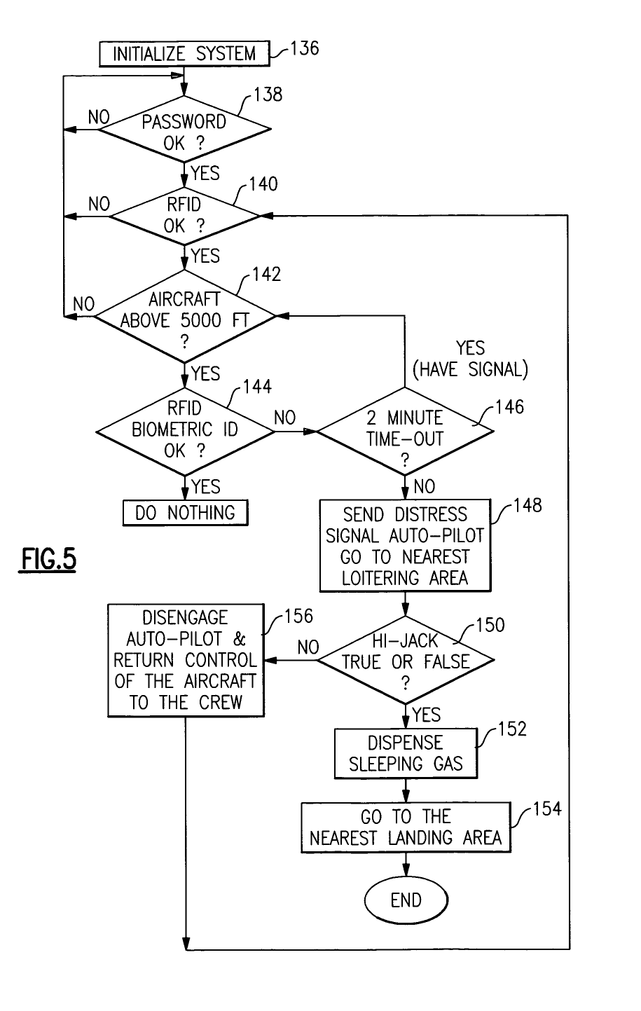

In a similar fashion, FIG. 4 is a broken-away perspective view of the biometric ID and password device 108 of FIG. 2 implemented in a steering wheel 130 of an automotive vehicle such as a car, truck, or bus. As illustrated, the steering wheel 130 includes the thumb cradle 122 smoothly integrated into the steering wheel 130 is a location that is in a natural position for the thumb at rest while the driver's hands are normally positioned for driving. FIG. 4 also shows the input device 124 in the key pad implementation integrated with the dashboard of the vehicle. Thus in this manner, the biometric ID and password system of the present invention may be employed in a car, truck, or bus to achieve the security aspects of the present invention.

As an additional safety feature, any transportation conveyance equipped with the biometric ID and password system 108, FIGS. 1 and 2, of the present system may further an alarm system to prevent the driver, pilot, or conductor from sleeping at the wheel. With continuing reference now to FIGS. 3 and 4, this is further illustrated an alarm light 132 and sound alarm speaker 134. Thus according to certain safety aspects of the present invention, even in the event there is not a security situation, the system 108 may be configured to activate the sound and light alarms 132 and 134 if after a predetermined time period either a password has not been inputted and, or alternatively, a thumb print check is overdue. In such a situation, the driver may simply have fallen asleep at the wheel, and this aspect of the system may then be employed to promptly wake any dosing driver, pilot, or conductor of a public or private transportation conveyance.

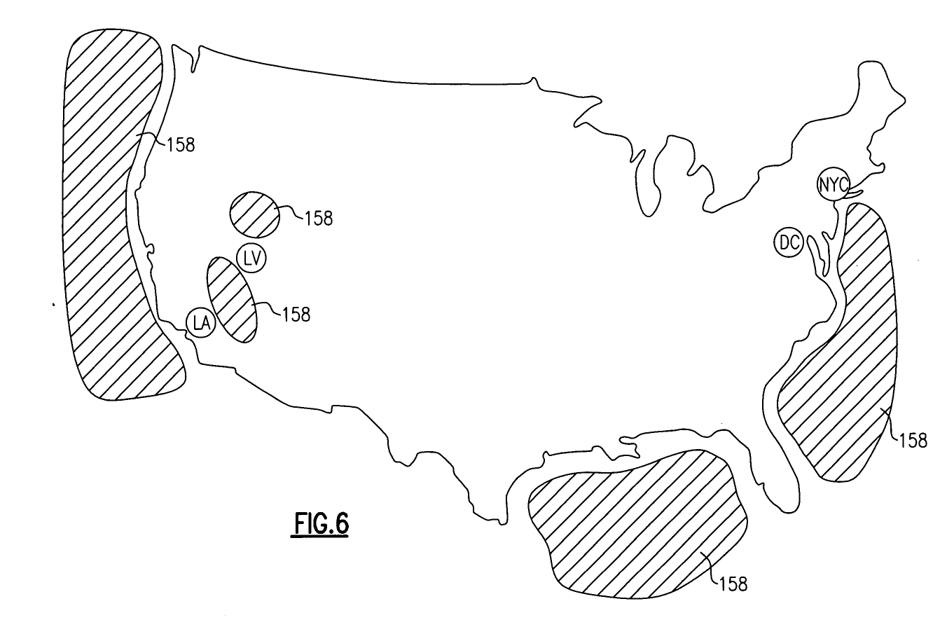

With reference next to FIG. 5, there is shown a is logic flow chart of one of the various methods associated with the RFID and biometric ID system according to the present invention as applied to an aircraft. This method is intended to be illustrative of the various methods made possible by the system as disclosed herein and is thus not intended to be limiting. At step 136, the system is initialized. At step 138, a password check is conducted by use of the input device 124. If the password check is positive, then at step 140 an RFID check is conducted. If the RFID check is positive, the system then conducts an altitude check at step 142. After the aircraft has reached a predetermined altitude, for example 5000 feet in this specific embodiment, the system at step 144 then asks for a biometric and RFID check at periodic intervals. If at step 144 the biometric and RFID checks remain positive, then the aircraft may be operated in normal manner. If, however, at step 144 either a RFID or biometric check fails or is negative, then the system will proceed to step 146 and take a time-out. In the case of this specific embodiment, the time-out is set for 2 minutes. If before the 2 minute time-out expires, the proper missing signal or signals from the RFID tag or pilot's thumb are detected, the system will proceed through steps 142 and 144 in a non-alert manner. If, however, the 2 minute time-out expires without the proper missing signal or signals from the RFID tag or pilot's thumb being detected by the system, the system will proceed to step 148 where the system will then send out a distress signal, place the aircraft on auto-pilot, and direct the aircraft to the nearest loitering area. At this point, the cockpit surveillance system may be activated so that ground control may have visual and audio inspection of the aircraft. Turning now to FIG. 6, there is shown a diagrammatic representation of the United States map illustrating the general location of Los Angles (LA), Las Vegas (LV), New York City (NYC), and Washington D.C. (DC). The map of FIG. 6 also shows loitering zones 158. These loitering zones are non-populated areas adjacent to the indicated cites of higher population. Thus at step 148 in the method of FIG. 5, the autopilot is configured to take an aircraft that is in a highly populated areas to an area of little or no population such as over a desert, national park, or bodies of water such as the Pacific or Atlantic ocean or the Gulf of Mexico. At step 150, ground control determines whether the present event is a hi-jacking situation. This may be achieved by the surveillance system, passengers making distress call by cell phone, communication for the cockpit, or other means. If a hijack situation has been determined, then at step 152 ground control may dispense sleeping gas to render unconscious any or all the persons in the aircraft. Once, the sleeping gas is dispensed, ground control proceeds to land the aircraft safely by autopilot at the nearest landing area as represented at step 154 of FIG. 5. If at step 150 the ground control determines that the event is not a hijacking and the all clear is established, then the autopilot will be remotely disengaged and control of the aircraft will be returned to the flight crew. It should be understood that in practicing this aspect of the present invention, once control of the aircraft is take remotely by ground control the aircraft is prevented from being operated manually in such a manner that any occupants in the aircraft are completely lockout from using any of the aircraft flight controls.

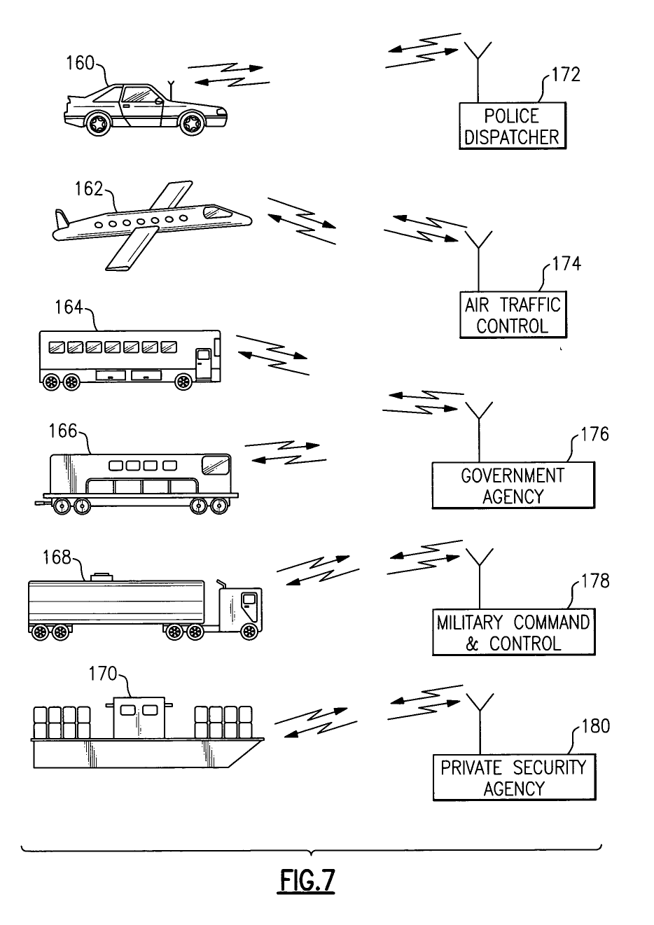

Next with reference to FIG. 7, there is shown a pictorial schematic view of a variety of different system configurations according to the present invention involving remotely dispatched control and security protocols from a fixed location for application to a transportation conveyance which has indicated a security alert. The present invention may thus be implemented in a car 160, an aircraft 162, a bus 164, any rail engine such as a freight train 166 or subway car, trolley, or streetcar, a tanker truck 168, or any watercraft such as cargo ship 170. Any of these transportation conveyances may be placed in communication with an authorized ground control to achieve the intended aspects of the present invention. As represented in FIG. 7, such authorized ground control by be implemented by a police dispatcher 172, air traffic control 174, a designated government agency 176, military command and control 178, or an authorized private security agency 180.

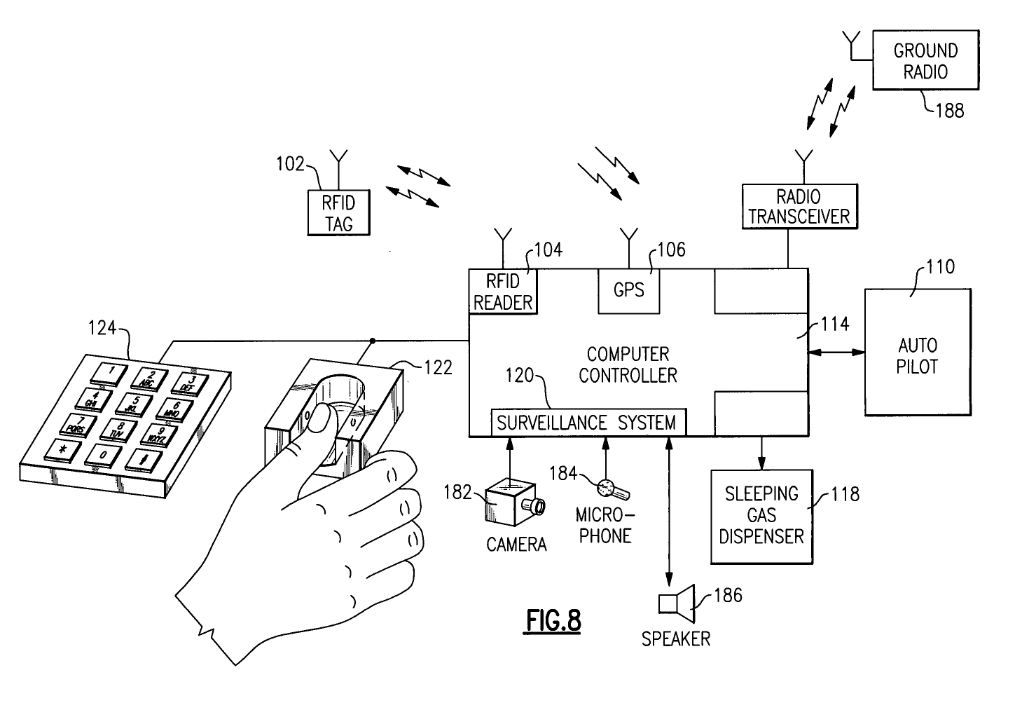

In FIG. 8, there is shown a perspective pictorial and block diagram of the principal components of a system according to the present invention that may be readily adapted to any of the transportation conveyances shown in FIG. 7. The present system as applied to these conveyances includes the RFID tag 102, the RFID reader 104, the radio transceiver 112, the computer and controller 114, the sleeping gas dispenser 118, the surveillance system 120, the biometric ID thumb cradle 122, and the password input device 124. the system may also preferably include the GPS, and in the case of transportation conveyances take are so adaptable, the autopilot 110 may be included. As illustrated in FIG. 8, the surveillance system 120 preferably includes a video camera, a microphone 184, and a communication speaker 186. The system of FIG. 8 is shown as also including a ground radio 188. The ground radio 188 is located remotely from the transportation conveyance and may be implemented at any of the authorized ground control installation illustrated in FIG. 7 which include the police dispatcher 172, the air traffic control 174, the designated government agency 176, the military command and control 178, or the authorized private security agency 180.

With reference now to FIG. 9, there is shown a block diagram similar to FIG. 8 showing alternative options for implementation of the ground radio system with various authorized dispatchers. In addition to the control radio signals being dispatched from a ground location; such control signals may also be dispatched by satellite transmission 190. Depending on the type of transportation conveyance, the on-board communication system 192 may be a CB radio, a car radio, a ship-to-shore radio, or the more sophisticated communication systems found in commercial aircraft. In all such cases, the transportation conveyance is equipped with the radio transceiver 112 implemented according to the teachings of the present disclosure. In each of the different transportation conveyances the subject hereof, there is typically included the engine or motor system 116 having an ignition system 196. Thus according to the present invention, in transportation conveyances that do not include an autopilot system 110, the various aspects of the present system are directed to cooperative communication and control links between the computer and controller 114 and the engine or motor system 116 including the ignition system 196.

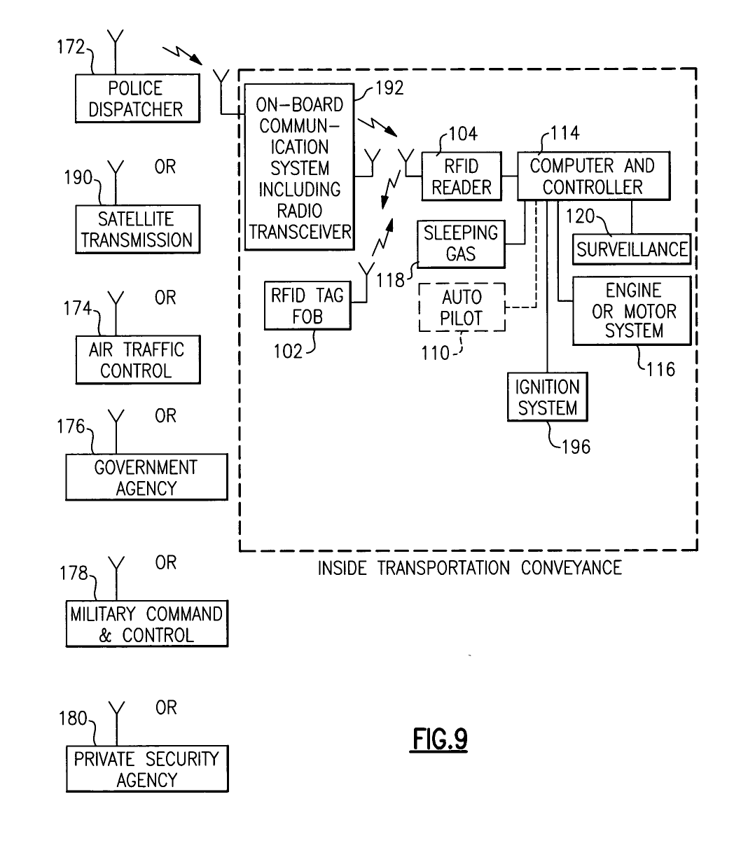

Referring next to FIG. 10, there is shown a block diagram illustrating some of the principal components of the ground radio system 188 of this invention as implemented in association with any of the authorized dispatcher locations of FIGS. 7 and 9. The ground radio system 188 as implemented according to the present invention is preferably a software defined radio system which is programmable to receive and transmit various signals which may be encoded, encrypted, or otherwise rendered proprietary or protected as would be understood by one of skill in the art. The radio system 188 illustrated in FIG. 10 thus includes RF circuitry 198 with an antenna, a micro-processor unit or MPU 200, random access memory or RAM 202, storage memory 204, a keyboard 206, and other input/output devices which may include a microphone, a monitor or display 210, and a speaker or speakers 212. In accordance with this aspect of the present invention, the memory 204 of the authorized radio system 188 includes a listing of vehicle identification numbers (VIN), loitering areas 158, FIG. 6, and may also include an indexing of driver, conductor, and pilot biometric IDs and passwords. As generally understood, the VIN is a seventeen alpha numeric sequence in the format “12,345,679,0AB,CDE,XYX”. Thus in this manner, in the event a particular car or truck 160 or 168, FIG. 7, is stolen or placed is use by those who intend to do harm by illegal use of the vehicle, the authorized dispatcher may quickly program the radio system 188 to broadcast a signal that is received by the vehicle radio transceiver 112, FIG. 1, which in turn will promptly disable operation of the car 160 or truck 168. As would be readily understood in view of the present disclosure, this system is not necessarily limited to the use of VIN. License plate numbers, for example, or other serial numbers or codes may be easily adopted and implemented in the alternative. This aspect of the present system may be readily adapted to the other types of transportation conveyances represented in FIG. 7

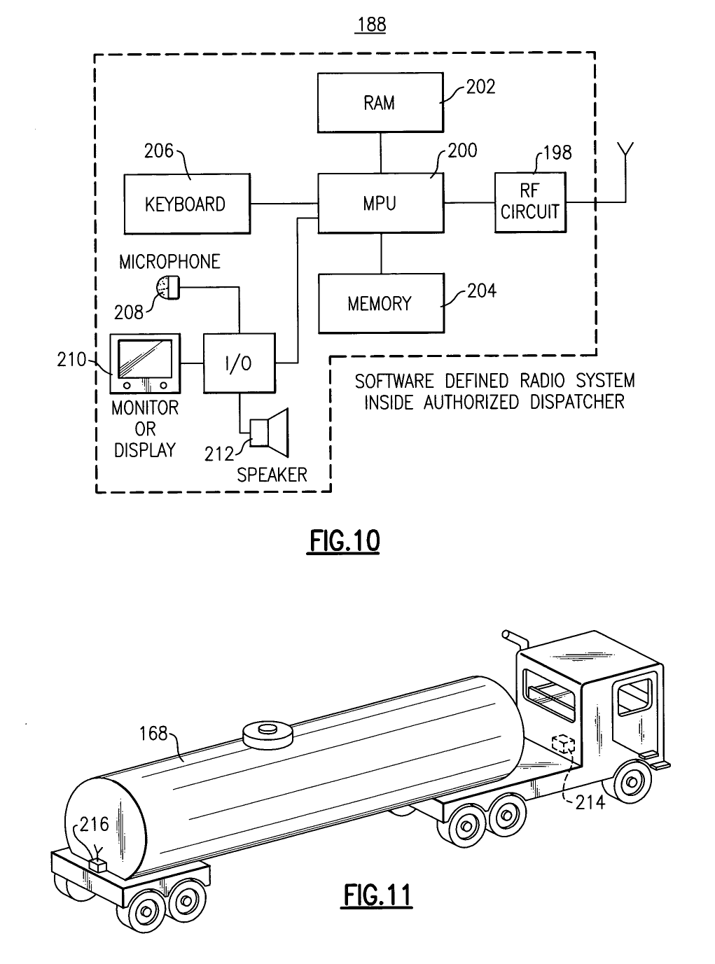

With reference now to FIG. 11, there is illustrated a rear perspective view of the tanker truck 168 showing in phantom line the vehicle's computer or ECU 214 which corresponds generally to the computer and controller 114 represented in FIG. 1, and an RFID embedded license plate 216 according to another aspect of the present invention. The RFID embedded license plate 216 is preferably only employed on the rear of the tanker truck 168. In this embodiment, the license plate of the truck has an imbedded RFID system which is enabled to work in conjunction with the trucks computer. Thus according to this aspect of the invention, if the truck is stolen and there is an attempt to change the license plate, the truck will become non-operative because the RFID transmitter embedded in the license plate is missing from the read zone of the vehicle's RFID reader. Thus any attempt to switch plates for criminal or violence purposes will be prevented by this aspect of the present invention.

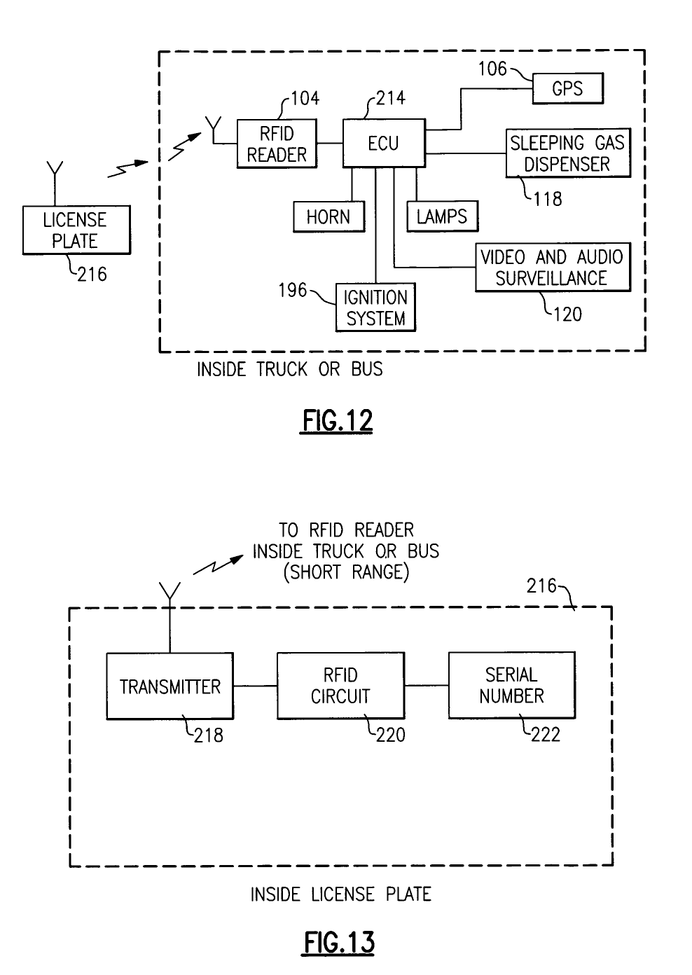

More particularly now with reference to FIG. 12, there is shown a block diagram including license plate 216 cooperatively interacting with the RFID reader 104 and engine control unit 214 of an RFID equipped vehicle. Thus in accordance with this aspect of the present invention, when the license plate 216 is removed from the read zone of the RFID reader 104, the ECU will detect the absence of the plate. This will in turn trigger one of various disable protocols which will then be executed by the ECU 214. Such protocols may include, for example, a “do-not-start” or “do-nothing” command if the vehicle is in a parked, non-moving condition when the license plate 216 is removed from the read zone of the RFID reader 104, or a “discontinue-fuel-flow” in the same case or if there is any attempt to remove the license plate 216 from the read zone of the RFID reader 104 when the vehicle is in motion. More commonly, other protocols may include “sound-horn” or “flash-lights” commands either executed individually, alternatively, or in combination with the “do-not-start” or “discontinue-fuel-flow” commands.

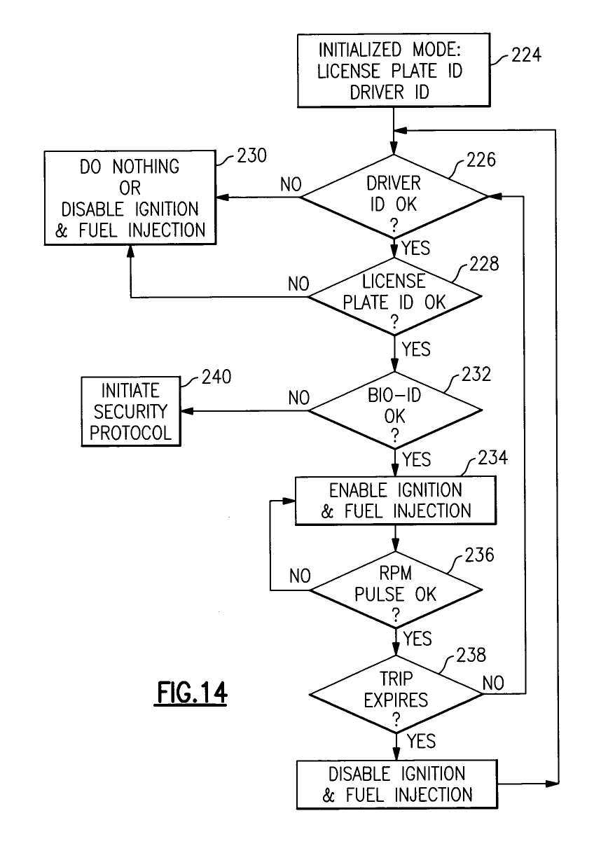

FIG. 13 is a block diagram illustrating the principal components of the RFID embedded license plate 216 of the present invention. As illustrated, the license plate 216 includes a transmitter 218, an RFID circuit 220, and a serial number 222. The RFID circuit may include memory for storing the serial number 222, or the serial number may simply be hard wired or otherwise hard coded in the RFID circuit 220. As illustrated in FIGS. 12 and 13, the distance between the license plate 216 and the RFID reader 104 is short range, preferably on the order of only a few inches or centimeters. In this manner, the plate 216 may not be removed from its proper location and otherwise placed in the truck to thereby be concealed from authorities and still be within the read zone of the reader 104. Thus placement of the antenna of the RFID reader would preferably be within the truck frame or a frame cavity located immediately adjacent the antenna of the license plate 216. As would be readily understood by one of skill in the art give the present disclosure, the serial number may include any convenient number such as the VIN, the actual number of the license plate, or any other code or number that for intended purposes uniquely associates the license plate with a specific vehicle.

Referring next to FIG. 14, there is shown a logic flow chart illustrating one of the various methods associated with the RFID embedded license plate 216 of the present invention as implemented in combination with the biometric ID and password unit 108 including the thumb cradle 122 and the password input device 124 shown in FIGS. 1, 2, and 4. As illustrated, one such preferred method is initiated at step 224 where the ECU 214 is engaged to run a license plate ID and driver ID routine. At step 226, first the driver ID is checked. This check is based on the driver having the proper RFID fob or tag 102, FIG. 1, associated with the vehicle. If the driver ID check is confirmed as OK, the routine will proceed to step 228, if not, then the routine will proceed to step 230 and the truck will be prevented from starting when it is in a stopped condition or if in a moving condition, the ECU 214 will disable ignition by reducing fuel injection to a “no-flow” condition. At step 228, the license plate ID is checked. If the license plate check is negative or “no”, the routine proceeds to step 230 and the “do-nothing” or “disable” commands are executed by the ECU. If the license plate check is positive, OK, or “yes”, the routine proceeds to step 232 to conduct a bio ID and password check. If the biometric ID and password check is positive, OK, or “yes”, the routine proceeds to step 234 and the truck is allowed to start. If the biometric ID or password check is negative, the system proceeds to step 240 and one of the various security protocols of the present invention is initiated. Once the truck is then running after all checks have been determined to be positive, step 236 then checks to determine whether RPM is generated. If the truck is stopped with the engine turned on, the engine function remains enabled. When the truck is stopped and the engine turned off, the “Trip Expires” step 238 disables the ignition function. If the trip has not expired, driver, license plate ID, and bio ID and password checks are repeated at preset timed intervals during the course of continued operation.

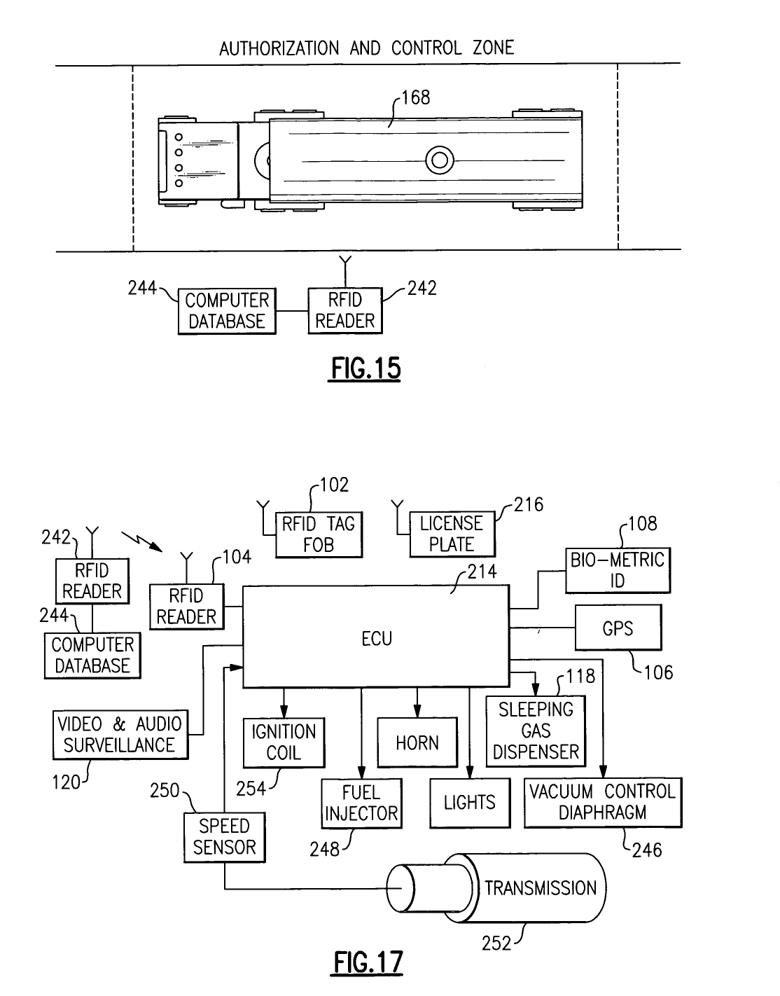

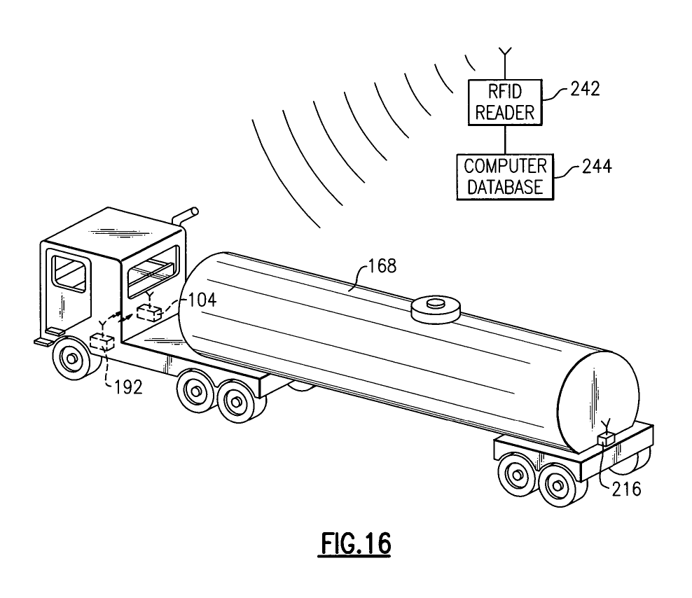

With reference now to FIGS. 15 and 16, there are shown a top and perspective views of the tanker truck 168 in a street-level authorization and control zone illustrating an interactive vehicle ID, authentication, and control system and methods according to another principal aspect of the present invention. The system includes the truck 168 as equipped with the invention hereof, and further includes a road side RFID reader 242 which is cooperatively connected to a computer or computer and computer database 244. As the truck 168 proceeds through the zone, the license plate 216 and the RFID tag 102 are emitting their short range signals. The read zone created by the road side RFID reader 242 is large enough to cover the entire authorization and control zone. Thus as the truck passes through the zone, the road side reader 242 reads either one or both of the signals emitted by the license plate 216 and the RFID tag 102. The computer data base 244 includes a listing of valid VIN, license plate numbers, passwords, and biometric ID, and any other types of codes that may be associated with the vehicle.

According to this aspect of the present invention, the license plate 216 has not been switched by a thief or high-jacker who has stolen the truck. In this situation, the truck equipped with the RFID license plate is being driven through the “authorization zone” as illustrated in FIG. 15. The trucks's computer is advantageously programmed and equipped with speed control response capabilities as further described below with reference to FIG. 17. In this manner, when the truck is driven through the zone, the road side RFID reader 242 reads the vehicle ID and operates to control the speed of the truck or otherwise completely disables the truck from operating. Many applications of this aspect of the present invention are envisioned by the inventor hereof. One such application, for example, is use of this system in controlled government areas such as military bases or diplomatic areas. Only cars and trucks with known IDs would be allowed to pass through the zone. In alternate embodiments of this system, the RFID transmitter need not necessarily be embedded in the license plate. Other configurations and locations of the transmitter/transponder and receiver system may be readily implemented according to the principal aspects of this invention.

Turning next to FIG. 17, there is shown a block diagram of the principal components of the interactive vehicle ID, authentication, and control system illustrated in FIGS. 15 and 16. Components thereof discussed above will not be initially repeated here for the sake of convenience. As illustrated, the ECU 214 is further engaged with a vacuum control diaphragm 246, a fuel injector 248, and a speed sensor 250 as associated with the vehicle's typical operational functions. The speed sensor 250 is connected between the ECU 214 and vehicle's transmission 252. In this manner, the ECU 214 (as programmed according to the various methods and protocols described herein) is enabled to control the speed of the truck and over-ride the drivers direct control when one of various different control signals is sent from the road side RFID reader 242 to the vehicle's RFID reader 104. For example, the vehicle may be completely stopped by deactivating the ignition coil 254. In addition, the speed of the vehicle may be controlled by a signal sent from the road side RFID reader 242 to the vehicle's RFID reader 104 which commands the ECU 214 to reduce the fuel rate in the fuel injector 248, or the amount of vacuum via the vacuum control diaphragm 246. The speed sensor 250 will give continuous feed back to the ECU 214 thus allowing speed reduction or stopping to be controlled in a precise and predictable manner.

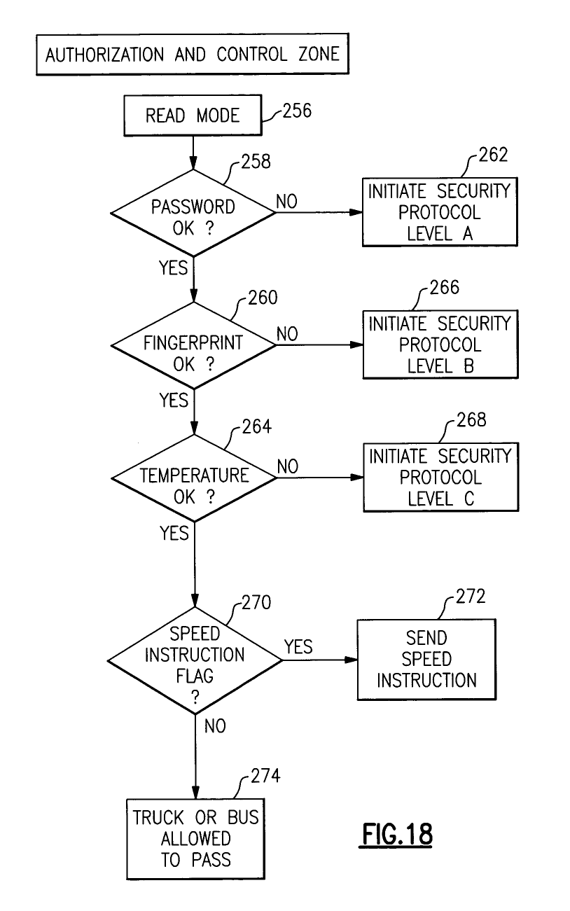

FIG. 18 is a logic flow chart showing one of the various preferred methods associated with the authorization and control zone aspect of the present invention. In this method, a read mode 256 is initiated by the system. At step 258, authorization by use of the password input device 124, FIG. 2, is checked. If the truck password is positive, the routine proceeds to step 260 and if not, a sentry alert signal is sent from the computer 244 and security protocol 262 is initiated. At step 260 the fingerprint check is performed, and then the temperature check is performed at step 264. If either of these checks is negative, then security protocols 266 and or 268 are initiated. As represented at step 262, a Level A security protocol may involve giving the system a time-out to allow the user time to re-enter the password. At step 266, a Level B security protocol may involve activating the in-cab surveillance system 120, FIG. 17, so that the authorized dispatcher may have video and or audio inspection of the cab. And at step 268, a Level C security protocol may involve remotely activating the ignition coil 254, fuel injector 248, or vacuum control diaphragm 246, FIG. 17, so that the truck is thereby stopped. Thereafter, a Level C security protocol may further involve the authorized dispatcher activating the sleeping gas dispenser 118. In view of the above, it should be understood that each of the above security protocols A, B, and C are presented herein by way of example and are not intended to be limiting as to the wide variety of possible security protocols that may readily be implemented give the various components and functionalities of the present invention.

According further to the speed control aspect of the invention, step 270 inserts an instruction flag into the signal which is sent to the truck's ECU. Such an instruction flag may be selected from the set including, for example, “A1=15 mph”, “A2=25 mph”, “A3=35 mph”, “A4=45 mph”, “A5=55 mph”, “A6=65 mph”, and “A7=75 mph”. In this manner at step 272, a “Send Speed Instruction” signal sends, for example the flag A3 in a 35 mile per hour zone to the vehicle. If the vehicle is exceeding 35 mph, the truck's ECU automatically takes corrective action to bring the speed of the truck within the requirement of the zone. In the last step 274, the truck is allowed to pass without shut down if the required speed and or authorization have been achieved.

With continued reference now to FIGS. 17 and 18, the vehicle's speed sensor 250 which is mounted on the output shaft of the transmission 252 sends electrical pulses to the computer or ECU 214, pulses which are generated by a magnet spinning past a sensor coil. When the vehicle's speed increases, the frequency of the pulses correspondingly increases. For any given speed of the vehicle there is a corresponding pulse frequency. It is this pulse frequency which the cruise control, for example, tries to maintain as a constant. The speed control part of the ECU 214 has three functions. First, it stores the speed control code of various speeds of the vehicle in the memory. When speed control flag (FIG. 18) is received by the ECU 214, the system will check for a speed table and send instructions accordingly, step 272 of FIG. 18. Second, it receives the pulses from the transmission sensor and compares the frequency of those pulses to the frequency value stored in its memory. This is defied as the “set point”. Third, it sends pulses to a vacuum controlled diaphragm 252 connected to the accelerator linkage. The pulses it sends regulates the amount of vacuum the diaphragm receives. The more pulses, the more vacuum and the more vacuum the more force on the accelerator linkage. The system continues to add vacuum force until the set point speed is reached. At that point the system modulates the amount of vacuum the diaphragm receives in an effort to maintain the number of pulses coming from the speed sensor as close to the stored value as possible.

While this invention has been described in detail with reference to certain preferred embodiments, it should be appreciated that the present invention is not limited to those precise embodiments. Rather, in view of the present disclosure which describes the current best mode for practicing the invention, many modifications and variations would present themselves to those of skill in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

What is claimed is:

1. An anti-hijacker system for use in association with a transportation conveyance having an engine or motor system, said anti-hijacker system including:
an RFID tag associated with an authorized user of the transportation conveyance;
a receiver enabled to read a signal transmitted from said RFID tag; and
a computer operatively connected to said receiver and the engine or motor system of the transportation conveyance so that in the absence of an expected signal from said RFID tag, said computer controls operation of the engine or motor system.

2. The anti-hijacker system according to claim 1 further including a GPS receiver operatively linked to said computer to thereby enable the computer to determine the location of the transportation conveyance at any desired time.

3. The anti-hijacker system according to either claim 1 or 2 further including a biometric ID unit enabled to identify said authorized user by a personal biological characteristic unique to said authorized user.

4. The anti-hijacker system according to claim 3 wherein said biometric ID unit requires an input password to be enabled to identify said authorized user by a personal biological characteristic unique to said authorized user.

5. The anti-hijacker system according to any one of claims 1 to 4 further including a radio transceiver operatively connected to said computer, said radio transceiver enabled to receive a control signal from a remote location.

6. The anti-hijacker system according to claim 5 wherein said transportation conveyance is an airplane.

7. The anti-hijacker system according to claim 6 further including an auto pilot system linked to said computer, said auto pilot system activated by said computer to autonomously control the airplane when said computer has determined said absence of said expected signal from said RFID tag.

8. The anti-hijacker system according to any one of claims 1 to 5 wherein said computer disables normal operation of the engine or motor system of the transportation conveyance in the absence of said expected signal from said RFID tag.

9. The anti-hijacker system according to any one of claims 1 to 8 further including a sleeping gas dispensing system that is operatively controlled by said computer so that upon a controlled command, said sleeping gas dispensing system is activated to render unconscious any would-be hijacker.

10. The anti-hijacker system according to any one of claims 1 to 9 further including a surveillance system operatively connected to said computer.

11. The anti-hijacker system according to claim 10 wherein said surveillance system includes video capability.

12. The anti-hijacker system according to either claim 10 or wherein said surveillance system includes audio capability.

13. The anti-hijacker system according to any one of claims 1 to 12 wherein said RFID tag is concealed on the person of said authorized user.

14. The anti-hijacker system according to claim 13 wherein said authorized user is a pilot, captain, conductor, driver, or other person responsible for operating the transportation conveyance.

15. The anti-hijacker system according to claim 13 wherein said authorized user is a law enforcement officer, intelligence agent, military personnel, or other person acting as a passenger on the transportation conveyance.

16. A method of preventing a transportation conveyance from being hijacked, said method comprising the steps of:
concealing an RFID tag on the person of an authorized user of the transportation conveyance; and
taking remote control of the engine or motor system of the transportation conveyance when an expected signal from said RFID tag is not received in an expected manner.

17. A method of preventing a transportation conveyance from being hijacked, said method comprising the steps of:
concealing an RFID tag on the person of an authorized user of the transportation conveyance; and
disabling operation of the engine or motor system of the transportation conveyance when an expected signal from said RFID tag is not received in an expected manner.

18. The method according to either claim 16 or 17 wherein said authorized user is a pilot, captain, conductor, driver, or other person responsible for operating the transportation conveyance.

19. The method according to either claim 16 or 17 wherein said authorized user is a law enforcement officer, intelligence agent, military personnel, or other person acting as a passenger on the transportation conveyance.

20. A method of preventing a transportation conveyance from being hijacked, said method comprising the steps of:
providing an authorized user of the transportation conveyance with an RFID tag that transmits a known signal;
providing a receiver enabled to read said signal transmitted from said RFID tag; and
providing a computer operatively connected to said receiver and the engine or motor system of the transportation conveyance so that in the absence of an expected signal from said RFID tag, said computer controls operation of the engine or motor system.

21. The method according to claim 20 further including the step of providing a GPS receiver operatively linked to said computer to thereby enable the computer to determine the location of the transportation conveyance at any desired time.

22. The method according to either claim 20 or 21 further including the step of providing a biometric ID unit enabled to identify said authorized user by a personal biological characteristic unique to said authorized user.

23. The method according to claim 22 further including the step of requiring an input password to said biometric ID to thereby be enabled to identify said authorized user by a personal biological characteristic unique to said authorized user.

24. The method according to any one of claims 20 to 23 further including the step of providing a radio transceiver operatively connected to said computer, said radio transceiver enabled to receive a control signal from a remote location.

25. A biometric and password system, comprising:
reader means for taking a biometric reading from a user to determine whether the user is an authorized user;
input means for the user to input a password into the system to determine whether the user has an authorized password; and
processing means to compare the biometric reading to the inputted password to determine whether the inputted password matches with the biometric reading.

26. The system according to claim 25 wherein said reader means includes heart sensing means for taking a temperature reading of the user.

27. A biometric and password system, comprising:
a reader implemented to take a biometric reading from a user to determine whether the user is an authorized user;
an input device enabled to receive a password and input said password into the system to determine whether the user has inputted an authorized password; and
a processor configured to compare the biometric reading to the inputted password to determine whether the inputted password matches with the biometric reading.

28. The system according to claim 27 wherein said reader includes a heart sensor for taking a temperature reading of the user.

29. The system according to claim 27 further including a database used to store known biometric IDs and passwords.

30. A piloting control and security system for use in an aircraft, said system comprising:
a yoke including a thumb cradle formed therein, said thumb cradle having a reader capable of reading a fingerprint of a user that places a finger in the thumb cradle, said reader being operatively connected to a processor; and
a password input device operatively connected to said processor so that when the user's fingerprint has been read by the reader and a password inputted into said password input device, said processor determines whether the user is an authorized user.

31. The system according to claim 30 wherein said thumb cradle includes a heat sensor enabled to take a temperature reading from the user.

32. A steering control and security system for use in an automotive vehicle, said system comprising:
a steering wheel including a thumb cradle formed therein, said thumb cradle having a reader capable of reading a fingerprint of a user that places a finger in the thumb cradle, said reader being operatively connected to a processor; and
a password input device operatively connected to said processor so that when the user's fingerprint has been read by the reader and a password inputted into said password input device, said processor determines whether the user is an authorized user.

33. The system according to claim 32 wherein said thumb cradle includes a heat sensor enabled to take a temperature reading from the user.

34. A steering control and security system for use in watercraft, said system comprising:
a pilot wheel including a thumb cradle formed therein, said thumb cradle having a reader capable of reading a fingerprint of a user that places a finger in the thumb cradle, said reader being operatively connected to a processor; and
a password input device operatively connected to said processor so that when the user's fingerprint has been read by the reader and a password inputted into said password input device, said processor determines whether the user is an authorized user.

35. The system according to claim 34 wherein said thumb cradle includes a heat sensor enabled to take a temperature reading from the user.

36. A method for determining authorized use of a transportation conveyance, said method comprising the steps of:
requiring a user of the transportation conveyance to carry an RFID tag;
requiring the user to input a password into a computer system associated with the transportation conveyance;
requiring the user to periodically conduct a biometric check during the course of operation of the transportation conveyance; and
initiating a security protocol in the event of an incorrect password entry, a negative biometric check, or a failure to receive an expected signal from said computer system.
